(19) United States
(12) Patent Application Publication
(10) Pub. No.: US 2025/0010296 A1
(43) Pub. Date: Jan. 9, 2025

(54) Well Assemblies and Related Systems and Methods

(71) Applicant: ILLUMINA, INC., San Diego, CA (US)

(72) Inventors: Jack Twomey, San Diego, CA (US); Maulik Patel, San Diego, CA (US); Menggian Lu, San Diego, CA (US); Jay Taylor, San Diego, CA (US)

(21) Appl. No.: 18/572,788

(22) PCT Filed: Mar. 24, 2023
(86) PCT No.: PCT/US2023/016260

§ 371 Date: Dec. 21, 2023

Related U.S. Application Data
(60) Provisional application No. 63/325,462, filed on Mar. 30, 2022.

(51) Int. Cl. B01L 3/00

(52) U.S. Cl. CPC B01L 3/502723; B01L 3/502738; B01L 2200/0684; B01L 2200/0689; B01L 2200/16; B01L 2400/0622

(57) ABSTRACT

Well assemblies and related systems and methods are disclosed. In accordance with an implementation, an apparatus includes a body having a first wall, a second wall, a cover, and an impermeable barrier. The first wall defines a well having a port and a distal end defining an opening having an opening perimeter. The second wall surrounds the first wall and has a distal end. The cover is coupled to the distal end of the first wall and covers the opening along the opening perimeter at a connected portion and uncoupled from the distal end of the first wall along the opening perimeter at an unconnected portion. The impermeable barrier is coupled to the distal end of the second wall and covers the well. The unconnected portion forms a vent that allows air flow out of the well.

### RELATED APPLICATION

This application claims the benefit of and priority to U.S. Provisional Patent Application No. 63/325,462, filed Mar. 30, 2022, the content of which is incorporated by reference herein in its entirety and for all purposes.

### BACKGROUND

Well assemblies used with, for example, sequencing platforms, may include liquid reagent that is kept frozen until use. Keeping the reagent frozen may involve using additional packaging and/or dry ice when transporting the reagent and may involve keeping the reagent within a freezer at a facility. The measures taken to keep the reagent frozen can raise the cost of shipping and may cause some facilities to purchase additional or larger freezers or other equipment to store the well assemblies. The use of ice packs, dry ice, and/or additional packaging when shipping frozen reagent may moreover reduce sustainability and increase waste. Significant amounts of time may be taken to defrost the frozen reagent prior to use.

### SUMMARY

Advantages over the prior art and benefits as described later in this disclosure can be achieved through the provision of well assemblies and related systems and methods. Various implementations of the apparatus and methods are described below, and the apparatus and methods, including and excluding the additional implementations enumerated below, in any combination (provided these combinations are not inconsistent), may overcome these shortcomings and achieve the benefits described herein.

The disclosed examples relate to well assemblies Including dried reagent that have increased shell life and stability as compared to liquid reagent and may be shipped and stored at ambient temperature. The disclosed well assemblies may thus be shipped and stored at less cost and may not be required to be stored in a freezer. Intermittently connected foil covers retain the dried reagent within wells while simultaneously allowing venting, thereby keeping manufacturing costs low.

In accordance with a first implementation, an apparatus includes a body having a first wall, a second wall, a cover, and an impermeable barrier. The first wall defines a well having a port and a distal end defining an opening having an opening perimeter. The second wall surrounds the first wall and has a distal end. The cover is coupled to the distal end of the first wall and covers the opening along the opening perimeter at a connected portion and uncoupled from the distal end of the first wall along the opening perimeter at an unconnected portion. The impermeable barrier is coupled to the distal end of the second wall and covers the well. The unconnected portion forms a vent that allows air flow out of the well.

In accordance with a second implementation, a method includes flowing liquid into a well containing reagent and having a port and a first wall having a distal end defining an opening and an opening perimeter. A cover is coupled to the distal end of the first wall and covers the opening along the opening perimeter at a connected portion and uncoupled from the distal end of the first wall along the opening perimeter at an unconnected portion. Air is vented through the unconnected portion.

In accordance with a third implementation, a heat stake for connecting foil to a well assembly includes a body and a head. The body has a first end and a second end. The first end is couplable to an actuator. The head is connected to the second end of the body and has a face. A staking surface of the lace includes a plurality of recessed areas.

In accordance with a fourth implementation, a method includes forming a well assembly having a body with an outer edge. The body defines a well having an opening and a port. The opening has an opening perimeter. The method also includes heat staking a cover to the body along the opening perimeter at a plurality of connected portions. Each connected portion is adjacent to an unconnected portion and each unconnected portion forms a vent that allows air flow while deterring cross-contamination. The method also includes hermetically sealing an impermeable barrier to the outer edge of the body of the well assembly.

In accordance with a fifth implementation, an apparatus includes a first wall defining a well having a port and a distal end defining an opening having an opening perimeter and a cover coupled to the distal end of the first wall and covering the opening along the opening perimeter at a connected portion and uncoupled from the distal end of the first wall along the opening perimeter at an unconnected portion. The unconnected portion forms a vent that allows air flow out of the well.

In further accordance with the foregoing first, second, third, fourth, and/or fifth implementations, an apparatus and/or method may further comprise or include any one or more of the following:

In an implementation, the apparatus includes dried reagent contained within the well.

In another implementation, the vent is sized to substantially retain the dried reagent within the well.

In another implementation, liquid is to flow into the well via the port and rehydrate the dried reagent.

In another implementation, the cover comprises foil.

In another implementation, the first wall has a height and the second wall has a height that is greater than the height of the first wall.

In another implementation, the impermeable barrier hermetically is connected to the body.

In another implementation, the body includes thermoplastic, and the impermeable barrier includes a foil with a lacquer backing for bonding to the thermoplastic.

In another implementation, the body includes a plurality of wells including the well, each of the plurality of wells having a corresponding opening and a port.

In another implementation, the body has a valve stator, A first stator port opens into the valve stator, a second stator port opens into the valve stator, a first fluidic line fluidically coupling the first stator port and the port of one of the plurality of wells, and a second fluidic line fluidically coupling the second stator port and the port of another one of the plurality of wells.

In another implementation, the distal end of the first wall has an annular surface.

In another implementation, the distal end of the first wall defines a notch and the unconnected portion is positioned between the portion of the distal end and the cover.

In another implementation, the unconnected portion includes a first unconnected portion and a second unconnected portion. A first portion of the distal end of the first wall defines a first notch and the first unconnected portion is positioned between the first notch and the cover and a second portion of the distal end of the first wall defines a second notch and the second unconnected portion is positioned between the second notch and the cover.

In another implementation, the first notch has a first arc length and the second notch has a second arc length.

In another implementation, portions of the distal end of the first wall define a plurality of notches. Each notch having a notch length. The plurality of unconnected portions are aligned with the plurality of notches. An unconnected length of each unconnected portion is commensurate with the notch length of a corresponding notch.

In another implementation, the connected portion includes a plurality of connected portions between which the cover and the distal end of the first wall are coupled and the unconnected portion comprises a plurality of unconnected portions between which the cover and the distal end of the first wall are uncoupled.

In another implementation, at least one of the unconnected portions of the plurality of unconnected portions is positioned between two of the connected portions of the plurality of connected portions.

In another implementation, the plurality of connected portions comprise radial connected portions and the plurality of unconnected portions comprise radial unconnected portions.

In another implementation, the apparatus includes a third wall defining a second well having a port and a distal end defining an opening having an opening perimeter, and a second cover coupled to the distal end of the third wall and covering the opening of the second well along the opening perimeter of the second well at a connected portion and uncoupled from the distal end of the third wall along the opening perimeter of the second well at an unconnected portion.

In another implementation, a fourth wall surrounds the third wall.

In another implementation, a total connected length of the connected portion is at least 25% of a circumference of the well.

In another implementation, the plurality of unconnected portions provide an air venting rate of approximately 0.083 cubic centimeters or less per second.

In another implementation, the apparatus includes a system configured to pierce the impermeable barrier.

In another implementation, the apparatus includes dried reagent contained within the well including microspheres having an average diameter of approximately 300 micrometers.

In another implementation, the vent is sized to substantially retain the dried reagent within the well.

In another implementation, the distal end of the first wall has an annular surface and the unconnected portion is positioned between the cover and the annular surface.

In another implementation, the distal end of the first wall defines a notch and the unconnected portion is positioned between the distal end and the cover.

In another implementation, the method includes piercing an impermeable barrier coupled to a distal end of a second wall, the second wall surrounding the first wall.

In another implementation, the method includes selectively flowing the liquid into the well or a second well.

In another implementation, selectively flowing the liquid into the well or the second well includes rotating a valve rotor within a valve stator between a first position that fluidically couples a liquid reservoir, a first stator port of the valve stator, and the port of the well, and a second position that fluidically couples the liquid reservoir, a second stator port of the valve stator, and a port of the second well.

In another implementation, heat staking the cover to the body includes applying a heat stake to the cover at a temperature between about 200 degrees Celsius and about 220 degrees Celsius.

In another implementation, heat staking the cover to the body includes applying the heat stake to the cover for a time period between about 1 second and about 3 seconds.

In another implementation, heat staking the cover to the body along the opening perimeter at a plurality of connected portions occurs before hermetically sealing the cover to the edge of the body of the well assembly.

In another implementation, the method includes placing dried reagent within the well before hermetically sealing the impermeable barrier to the edge of the body of the well assembly and before heat staking the cover to the body along the opening perimeter.

In another implementation, forming the well assembly comprises injection molding the well assembly.

It should be appreciated that all combinations of the foregoing concepts and additional concepts discussed in greater detail below (provided such concepts are not mutually inconsistent) are contemplated as being part of the subject matter disclosed herein and/or may be combined to achieve the particular benefits of a particular aspect. In particular, all combinations of claimed subject matter appearing at the end of this disclosure are contemplated as being part of the subject matter disclosed herein.

### BRIEF DESCRIPTION OF THE DRAWINGS

FIG. 1 illustrates a schematic diagram of an implementation of a system in accordance with the teachings of this disclosure.

FIG. 2 is a top view of an implementation of a reagent cartridge that can be used to implement the reagent cartridge of FIG. 1.

FIG. 3 is a bottom view of the reagent cartridge of FIG. 2 showing the ports of the wells, the stator ports, and the fluidic lines fluidly coupling the wells and the stator ports.

FIG. 4 is cross-sectional view of the reagent cartridge of FIG. 2.

FIG. 5 is a top view of a group of the wells that can be used to implement the well assembly of FIG. 1, the first group of the wells of the reagent cartridge of FIG. 2, or the second group of the wells of the reagent cartridge of FIG. 2.

FIG. 6 illustrates a perspective view of a heat stake that can be used to manufacture the well assemblies disclosed.

FIG. 7 illustrates a flowchart for a method of rehydrating the reagent of the reagent cartridges disclosed.

FIG. 8 illustrates a flowchart for a method of manufacturing the well assemblies of the reagent cartridges disclosed.

### DETAILED DESCRIPTION

Although the following text discloses a detailed description of implementations of methods, apparatuses and/or articles of manufacture, it should be understood that the legal scope of the property right is defined by the words of the claims set forth at the end of this patent. Accordingly, the following detailed description is to be construed as examples only and does not describe every possible implementation, as describing every possible implementation would be impractical, if not impossible. Numerous alternative implementations could be implemented, using either current technology or technology developed after the filing date of this patent. It is envisioned that such alternative implementations would still fall within the scope of the claims.

The implementations disclosed herein relate to consumables for instruments such as sequencing instruments. The consumables may be a reagent cartridge and include a well assembly and a perforated and/or partially sealed foil heat seal for a well assembly and related devices and methods that allow lyophilized reagents to be retained within a well of the well assembly and rehydrated. An outer perimeter heat seal around the well assembly body creates a hermetic seal that prevents or inhibits the reagent from being inadvertently rehydrated. The outer perimeter heat seal is subsequently pierced by the instrument prior to rehydrating the reagent. Internally of the seal, the foil is tacked down to each individual well in a perforated and/or partially sealed pattern.

With the introduction of lyophilized reagents in the form of microspheres to cartridges, a method to retain the flowable spheres in place is needed. The microspheres are able to easily travel throughout the well and outside or into neighboring wells if not retained. The retention method may keep the majority of microspheres within the well and allow them to be rehydrated then mixed into solution, without significant concentration loss or cross contamination of neighboring wells. The retention method should also not add much cost to the consumable by means of additional materials or processes. A perforated and/or partially sealed foil heat seal as disclosed allows for fewer material conversions and fewer process steps, greatly reducing the manufacturing costs. The foil may be partially sealed to the corresponding well(s) to allow venting.

According to some methods, the foil seal may be secured to the well assembly by a heat stake head having a face with a plurality of raised portions extending between and along an outer perimeter and an inner perimeter of the face. The raised portions secure connected portions of the foil seal along the perimeter of the well opening Unconnected portions of the foil seal allow venting.

According to other methods, the perimeter of the well opening may have a plurality of notches. The foil seal may be secured to the notches by a typical flat heat stake in order to create connected portions of the foil seal along the perimeter of the well opening. Unconnected portions of the foil seal aligned with and commensurate in length with the notches then allow venting.

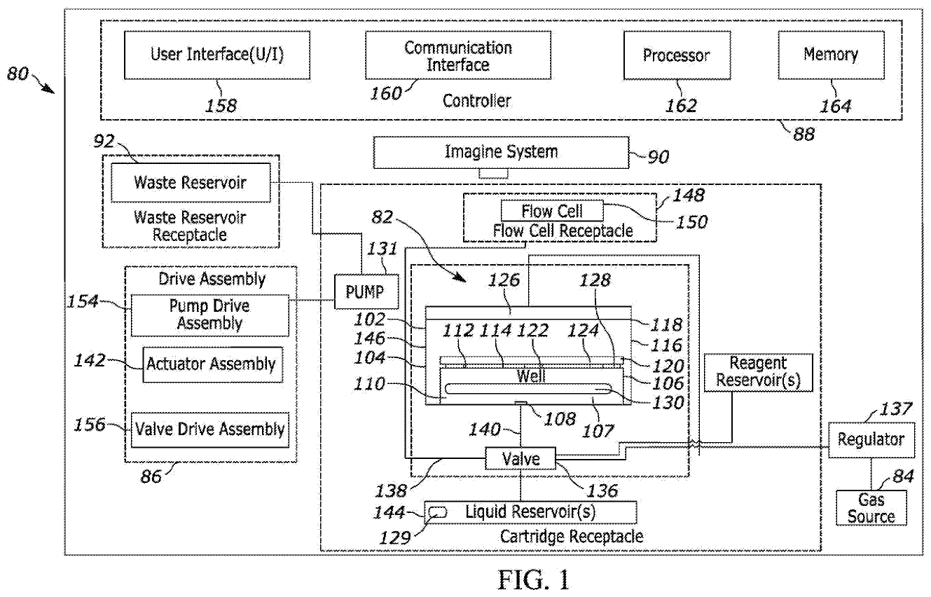

FIG. 1 illustrates a schematic diagram of an implementation of a system 80 in accordance with the teachings of this disclosure. The system 80 can be used to perform an analysis on one or more samples of interest. The sample may include one or more DNA clusters that have been linearized to form a single stranded DNA (sstDNA). In the implementation shown, the system 80 receives a reagent cartridge 82 and includes, in part, a gas source 84, a drive assembly 86, a controller 88, an imaging system 90, and a waste reservoir 92. The reagent cartridge 82 may be referred to as a consumable, a reagent reservoir, or a reagent assembly. The controller 88 is electrically and/or communicatively coupled to the drive assembly 86 and to the imaging system 90 and causes the drive assembly 86 and/or the imaging system 90 to perform various functions as disclosed herein.

The reagent cartridge 82 in the implementation shown includes a well assembly 102 having a body 104. The body 104 has a first wall 106 defining a well 107 having a port 108. The first wall 106 has a distal end 110 that defines an opening 112 having an opening perimeter 114. A second wall 116 surrounds the first wall 106 and has a distal end 118. The distal end 118 may be referred to as an edge or an outer edge. A cover 120 is coupled to the distal end 110 of the first wall 106 and covers the opening 112 along the opening perimeter 114 at a connected portion 122 and uncoupled from the distal end 110 of the first wall 106 at an unconnected portion 124. The connection portion 122 may be referred to as connection sections or connected segments and the unconnected portion 124 may be referred to as unconnected sections or unconnected segments. The first wall 106 has a height and the second wall 116 has a height that is greater than the height of the first wall 106. The first well 106 and the second well 116 may alternatively be the same or similar heights.

An impermeable barrier 126 is coupled to the distal end 118 of the second wall 116 and covers the well 107. The impermeable barrier 126 may be foil, plastic, etc. and may prevent or inhibit moisture from infiltrating the wells 107 of the reagent cartridge 82.

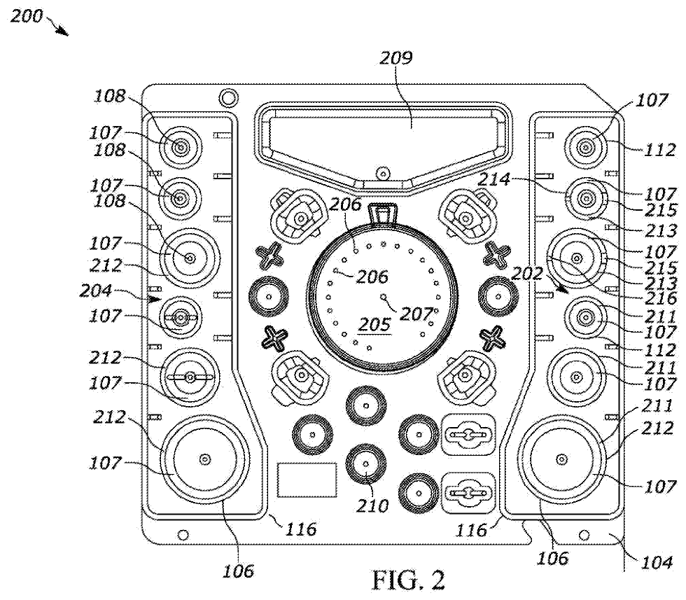

The unconnected portion 124 of the cover 120 forms a vent 128 that allows air flow out of the well 107. Dried reagent 130 is contained within the well 107, and the vent 128 is sized to substantially retain the dried reagent 130 within the well 107. The unconnected portion 124 provides an air venting rate of approximately 0.083 cubic centimeters or less per second. The unconnected portion 124 may provide a combined minimum venting rate of 0.004 cubic centimeters per second in some examples. Other air venting rates may prove suitable. Each unconnected portion 124 may have an unconnected length of about 4 millimeters (mm) and the diameter of the microspheres may be approximately 300 micrometres. The unconnected portion 124 may be a different length and the microspheres may be a different size, however. The body 104 may include a plurality of wells 107 while one well 107 is shown in FIG. 1 (see, FIG. 2, for example). Such an approach may simplify storage requirements, reduce shipping costs, and increase the speed of workflows by, for example, avoiding thaw time before the reagent may be used.

Liquid 129 can flow into the well 107 via the port 108 in practice to rehydrate the dried reagent 130. The vent 128 may vent gas from the well 107 as the liquid 129 flows into the well 107 and the cover 120 prevents or inhibits the reagent 130 and/or the liquid 129 from escaping from the well 107. Put another way, the vents 128 retain the reagent 130 and/or the liquid 129 within the wells 107 and prevents or inhibits the reagent 130 and/or the liquid 129 from migrating out of the wells 107. The vent 128 and the cover 120 prevents or inhibits cross-contamination between reagents when the reagent cartridge 82 includes more than one well 107 (See, FIG. 2, for example). The liquid 129 and the dried reagent 130 can be flowed into and out of the well 107 to mix the liquid 129 from the liquid reservoir 144 and the dried reagent 130. The system 80 and/or the reagent cartridge 82 may include a mixing chamber that is used to mix the liquid 129 and the dried reagent 130 in some implementations. The impermeable barrier 126 can be pierced prior to the liquid 129 flowing into the well 107.

The gas source 84 may be used to pressurize the liquid reservoir 144 to flow the liquid 129 into the well 107 and/or a pump 131 may draw the liquid 129 from the liquid reservoir 144 and flow the liquid 129 into the well 107 to rehydrate the reagent 130. The gas source 84 may be provided by the system 80 and/or may be carried by the reagent cartridge 82. The gas source 103 may alternatively be omitted. The pump 131 may be implemented by a syringe pump, a peristaltic pump, a diaphragm pump, etc. While the pump 131 may be positioned downstream of the flow cell 150 as shown, the pump 131 may be positioned upstream of the flow cell 150 or omitted entirely.

The reagent cartridge 82 and/or the system 80 includes valves 136 that may be selectively actuatable to control the flow of fluid through fluidic lines 138, 140. One or more of the valves 136 may be implemented by a valve manifold, a rotary valve, a selector valve, a pinch valve, a flat valve, a solenoid valve, a check valve, a piezo valve, etc. A regulator 137 can be positioned between the gas source 84 and the valve 136 and regulates a pressure of the gas provided to the valve 136. The regulator 137 may be a valve that controls the flow of the gas from the gas source 84.

The system 80 may pierce the impermeable barrier 126, the impermeable barrier 126 may be pierced by an individual prior to use, or the impermeable barrier 126 may be pierced by some other structure or methodology. The system 80 includes an actuator assembly 142 in the implementation shown that interfaces with the impermeable barrier 126 to pierce the impermeable barrier 126. The system 80 may include a protrusion such as a post having a blunt or sharp end that is movable by the actuator assembly 142 to pierce the impermeable barrier 126. The impermeable barrier 126 may alternatively be pierced by an operator prior to the reagent cartridge 82 being positioned in the system 80. The system 80 also includes a liquid reservoir 144 containing the liquid 129. The liquid 129 may be a rehydrating liquid and/or a wash buffer such as 8 mM MgOAc+0.1% Tween 20. The liquid 129 may be a different type of liquid, however.

The body 104 of the well assembly 102 has an edge 146 and the impermeable barrier 126 may be hermetically connected to the body 104 along the edge 146. The edge 146 may be referred to as an outer edge. The body 104 includes a thermoplastic and the impermeable barrier 126 is a foil with a lacquer backing for bonding to the thermoplastic of the body 104 in some implementations. The lacquer is a coating applied to the impermeable barrier 126 that promotes the bonding to the body 104 when heat staked, for example. The impermeable barrier 126 may alternatively be plastic or made of another material. The body 104 and/or the reagent cartridge 82 may additionally or alternatively include polypropylene and/or cyclic olefin copolymer (COC) with an over molded Santoprene thermoplastic elastomer (TPE) or another thermoplastic elastomer. Other materials may prove suitable for the reagent reservoirs 198 and/or the reagent cartridge 82.

The system 80 includes a flow cell receptacle 148 that receives a flow cell 150. As used herein, a “flow cell” can include a device having a lid extending over a reaction structure to form a flow channel therebetween that is in communication with a plurality of reaction sites of the reaction structure, and can include a detection device that detects designated reactions that occur at or proximate to the reaction sites. The flow cell 150 may alternatively be carried by and/or integrated into the reagent cartridge 82. The flow cell 150 may not be removably receivable within the reagent cartridge 82 if the flow cell 150 is integrated into the reagent cartridge 82.

The flow cell 150 may carry the sample of interest. The gas source 84 and/or the pump 131 may flow the liquid 129 to rehydrate dry reagents 130 and to flow one or more liquid reagents (e.g., A, T, G, C nucleotides) through the reagent cartridge 82 that interact with the sample.

The reagent with a reversible terminator in an implementation allows a single nucleotide to be incorporated by the sstDNA per cycle. One or more of the nucleotides has a unique fluorescent label in such implementations that emits a color when excited. The color (or absence thereof) is used to detect the corresponding nucleotide. The imaging system 80 excites one or more of the identifiable labels (e.g., a fluorescent label) in the implementation shown and thereafter obtains image data for the identifiable labels. The labels may be excited by incident light and/or a laser and the image data may include one or more colors emitted by the respective labels in response to the excitation. The image data (e.g., detection data) may be analyzed by the system 80. The imaging system 90 may be a fluorescence spectrophotometer including an objective lens and/or a solid-state imaging device. The solid-state imaging device may include a charge coupled device (CCD) and/or a complementary metal oxide semiconductor (CMOS).

After the image data is obtained, the drive assembly 86 interfaces with the reagent cartridge 82 to flow another reaction component (e.g., a reagent) through the flow cell 150 that is thereafter received by the waste reservoir 92 and/or otherwise exhausted by the reagent cartridge 18. The reaction component performs a flushing operation that chemically cleaves the fluorescent label and the reversible terminator from the sstDNA. The sstDNA is then ready for another cycle.

Referring now to the drive assembly 86, in the implementation shown, the drive assembly 86 includes a pump drive assembly 154, a valve drive assembly 156, and the actuator assembly 142. The pump drive assembly 154 interfaces with the pump 131 to pump fluid through the reagent cartridge 82 and/or the flow cell 150 and the valve drive assembly 156 interfaces with the valve 136 to control the position of the valve 136.

Referring to the controller 88, in the implementation shown, the controller 88 includes a user interface 158, a communication interface 160, one or more processors 162, and a memory 164 storing instructions executable by the one or more processors 162 to perform various functions including the disclosed implementations. The user interface 158, the communication interface 160, and the memory 164 are electrically and/or communicatively coupled to the one or more processors 162.

In an implementation, the user interface 158 receives input from a user and provides information to the user associated with the operation of the system 80 and/or an analysis taking place. The user interface 158 may include a touch screen, a display, a keyboard, a speaker(s), a mouse, a track ball, and/or a voice recognition system. The touch screen and/or the display may display a graphical user interface (GUI).

In an implementation, the communication interface 160 enables communication between the system 80 and a remote system(s) (e.g., computers) via a network(s). The network(s) may include an intranet, a local-area network (LAN), a wide-area network (WAN), the intranet, etc. Some of the communications provided to the remote system may be associated with analysis results, imaging data, etc. generated or otherwise obtained by the system 80. Some of the communications provided to the system 80 may be associated with a fluidics analysis operation, patient records, and/or a protocol(s) to be executed by the system 80.

The one or more processors 162 and/or the system 80 may include one or more of a processor-based system(s) or a microprocessor-based system(s). In some implementations, the one or more processors 162 and/or the system 80 includes a reduced-instruction set computer(s) (RISC), an application specific integrated circuit(s) (ASICs), a field programmable gate array(s) (FPGAs), a field programmable logic device(s) (FPLD(s), a logic circuit(s), and/or another logic-based device executing various functions including the ones described herein.

The memory 164 can include one or more of a hard disk drive, a flash memory, a read-only memory (ROM), erasable programmable read-only memory (EPROM), electrically erasable programmable read-only memory (EEPROM), a random-access memory (RAM), non-volatile RAM (NVRAM) memory, a compact disk (CD), a digital versatile disk (DVD), a cache, and/or any other storage device or storage disk in which information is stored for any duration (e.g., permanently, temporarily, for extended periods of time, for buffering, for caching).

FIG. 2 is a top view of an implementation of a reagent cartridge 200 that can be used to implement the reagent cartridge 82 of FIG. 1. The reagent cartridge 200 includes a plurality of the wells 107, each having a port 108 and an opening 112. The wells 107 may be referred to as a first well, as second well, etc. A first group 202 of the wells 107 is surrounded by a second wall 116 and a second group 204 of the wells 107 is surrounded by another second wall 116.

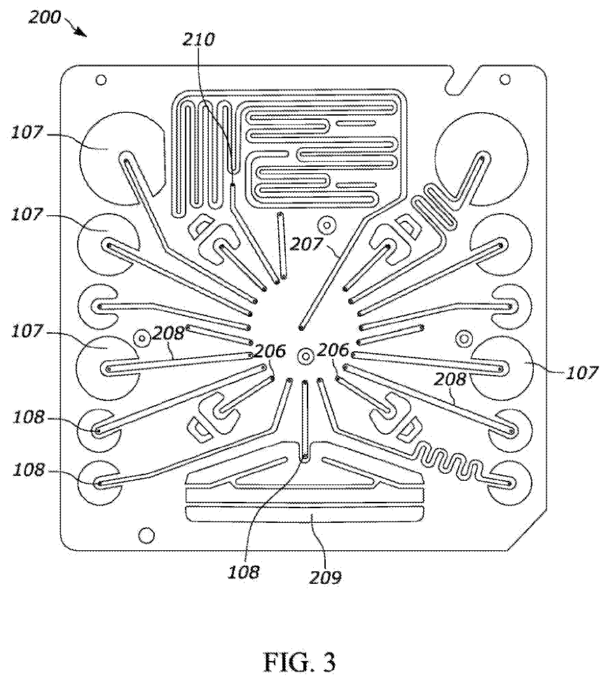

The body 104 of the reagent cartridge 200 in the implementation shown has a valve stator 205 that receives a valve rotor. The valve stator 205 and the valve rotor may be used to implement the valve 136 of FIG. 1. The valve stator 205 incudes a plurality of stator ports 206 and a common fluidic line 207 (see, FIG. 3). The stator ports 206 are fluidly coupled to the ports 108 of the wells 107 by corresponding fluidic lines 208 (see. FIG. 3) and the common fluidic line 207 is fluidly coupled to an outlet port 210.

The outlet port 210 may be fluidly coupled to the liquid reservoir 144 and/or the flow cell 150. The valve drive assembly 156 may rotate the valve rotor in practice to selectively fluidly couple the stator ports 206 and the common fluidic line 207 and, thus, allow the liquid 129 and/or the rehydrated reagent 130 to flow into and/or out of the reagent cartridge 200. The stator ports 206 may be referred to as a first stator port, a second stator port, etc. and the fluidic lines 208 may be referred to as a first fluidic line, a second fluidic line, etc. The valve rotor may be carried by the reagent cartridge 200 in some implementations. The valve rotor may alternatively be carried by the system 80 and movable to engage and interface with the valve stator 205.

The body 104 also includes a liquid reservoir 209 in the implementation shown that may be filled with the liquid 129 by the system 80. The liquid reservoir 209 may thus be empty prior to the reagent cartridge 200 being received within a reagent receptacle of the system 80 and the reagent cartridge 200 may be dry shipped.

Some of the first walls 106 of the wells 211 have an annular surface 212. The unconnected portion 124 may be positioned between the cover 120 and the annular surface 212 when the cover 120 is coupled to the connected portions 122 of the annular surface 212. Others of the first walls 213 have arch-shaped surfaces 214 and define a notch 215, 216. The notches 215, 216 are shown positioned between the arc-shaped surfaces 214. The wells 213 are shown including two notches 215, 216 that oppose one another in the implementation shown. The wells 213 may include any number of notches in any position, however.

Each notch 215, 216 has a notch length and the unconnected portions 124 are aligned with the notches 215, 216. The first notch 215 has a first arc length and the second notch 216 has a second arc length that is smaller than the first arc length. An unconnected length of each unconnected portion 124 commensurate with the notch length of a respective notch 215, 216. A total connected length of the connected portion is at least 25% of a circumference of the well 107.

The unconnected portions 124 may be positioned between the cover 120 and the notch 215, 216 when the cover 120 is coupled to the connected portions 122 of the annular surface 212. Some of the wells 107, 213 may thus include more than one unconnected portion 124 such as two or three unconnected portions 124.

FIG. 3 is a bottom view of the reagent cartridge 200 of FIG. 2 showing the ports 108 of the wells 107, the stator ports 206, and the fluidic lines 208 fluidly coupling the wells 107 and the stator ports 206. The common fluidic line 207 is also shown.

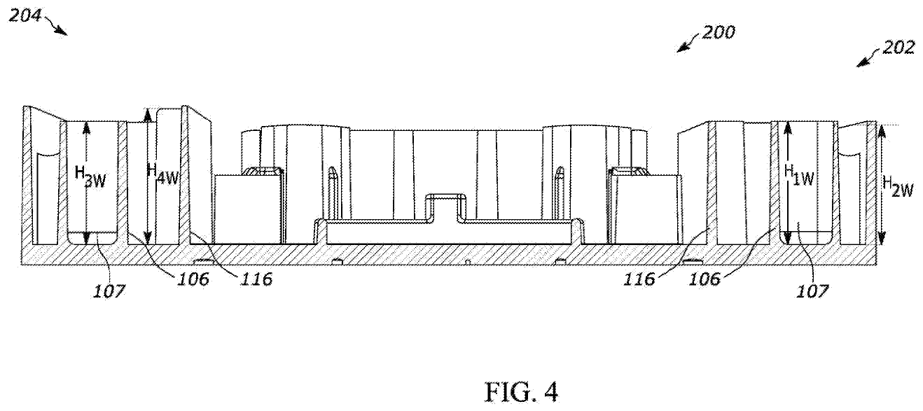

FIG. 4 is cross-sectional view of the reagent cartridge 200 of FIG. 2. The reagent cartridge 200 includes the first group 202 of the wells 107 and the second group 204 of the wells 107. The first wall 106 of the wells 107 of the first group 202 have a first wall height H1W that is substantially equal to a second wall height H2W of the second wall 116 and the first wall 106 of the wells 107 of the second group 204 have a third wall height H3W that is less than a fourth wall height H4W of the second wall 116. The walls 106, 116 of any of the wells 107 may be any height, however.

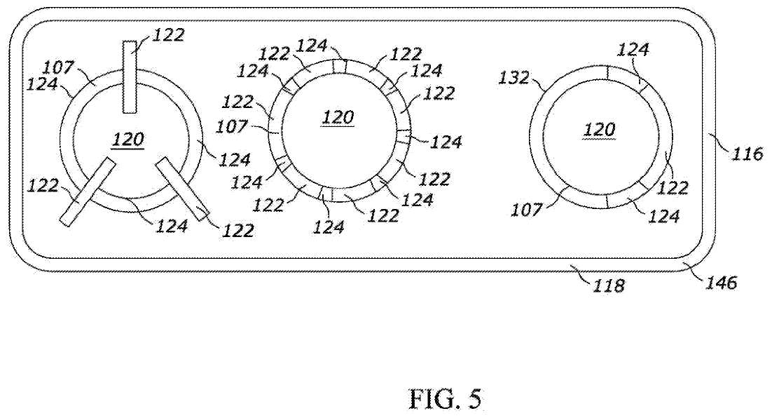

FIG. 5 is a top view of a group 300 of the wells 107 that can be used to implement the well assembly 102 of FIG. 1, the first group 202 of the wells 107 of the reagent cartridge 200 of FIG. 2, or the second group 204 of the wells 107 of the reagent cartridge 200 of FIG. 2. The cover 120 is shown covering the wells 107 of the group 300.

The leftmost cover 120 and the well 107 includes three long unconnected portions 124 held in place by three connected portions 122 disposed substantially perpendicular to the long unconnected portions 124. The unconnected portions 124 are shown positioned about 120 degrees relative to one another. The center cover 120 and the well 107 includes a plurality of short unconnected portions 124 alternating with longer connected portions 122 of varying lengths. The rightmost cover 120 and the well 107 includes two relatively short unconnected portions 124 alternating with two longer connected portions 122 of two different lengths, Other variations of unconnected portions 124 and connected portions 122 are possible, including unconnected portions 124 and connected portions 122 of similar or differing lengths and similar or differing orientations. The edge 146 of the well assembly 300 is also shown and would be connected to the impermeable barrier 126 shown in FIG. 1. The edge 146 is shown being the distal end 118 of the second wall 116.

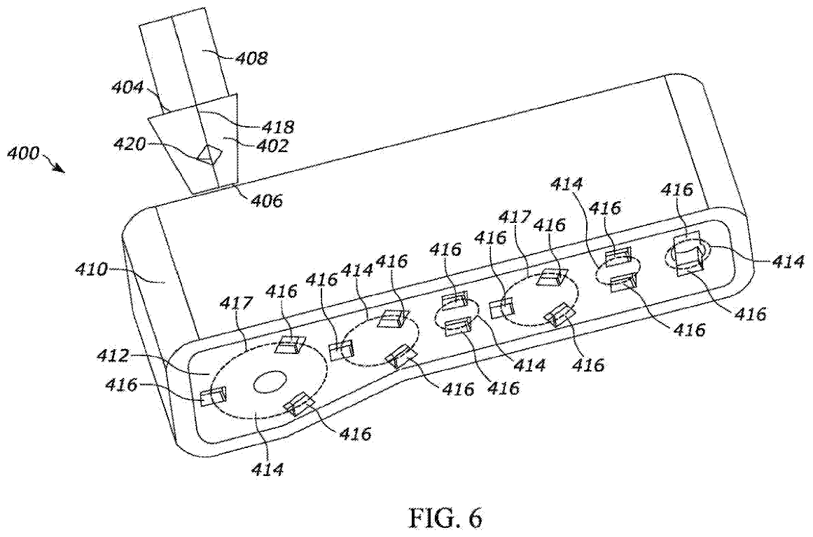

FIG. 6 illustrates a perspective view of a heat stake 400 that can be used to manufacture the well assemblies 102 disclosed. The heat stake 400 may be used to form the connected portions 122 between the cover 120 and the corresponding well 107 and to form the unconnected portions 124 between the cover 120 and the well 107. The heat stake 400 may be used to couple the cover 120 to the wells 107 of the first group 202 and/or the second group 204 of the reagent cartridge 200 of FIG. 2, for example.

The heat stake 400 includes a body 402 having a first end 404 and a second end 406. The first end 404 is couplable to an actuator 408 to move the heat stake 400. The heat stake 400 also includes a head 410 that is connected to the second end 406 of the body 402. The head 410 has a face 412. The face 412 of the heat stake 400 has six staking surfaces 414 within circular dotted lines in the implementation shown. Each staking surface 414 includes a plurality of recessed areas 416 and flat surfaces 417 between the recessed areas 416. The flat surfaces 417 are formed by the face 412 of the head 410. The recessed areas 416 correlate with the unconnected portions shown 124 of the reagent cartridge 200 of FIG. 2 and the flat surfaces 417 correlate to the connected portions 122.

The leftmost staking surface 414 has three recessed areas 416 that are substantially equally spaced and the rightmost staking surface 414 has two recessed areas 416 that oppose one another in the implementation shown. The recessed areas 416 are depicted as being substantially the same in size for each staking surface 414. The recessed areas 416 may be different sizes and/or shapes and may be distributed unequally around each staking surface 414 to achieve the desired arrangement of connected and unconnected portions of a cover 120, however, and as shown in FIG. 4.

The body 402 of the heat stake 400 has an axis 418. A gimbal 420 may be incorporated into or otherwise carried by the body 402 as shown schematically at diamond. The gimbal 420 allows rotation of the head 410 relative to the axis 418. The gimbal 420 may alternatively or additionally be implemented by a spring. The spring may bias the head 410 to a first position with the face 412 of the head 410 in a first plane, the head 410 adjustable via the spring to a second position with the face 412 of the head 410 in a second plane. Both the gimbal 420 or the spring serve the purpose of ensuring that the face 412 of the head 410 will come into contact with all relevant portions of a well assembly 102 to secure the cover 120 to the well assembly 102 in the desired manner.

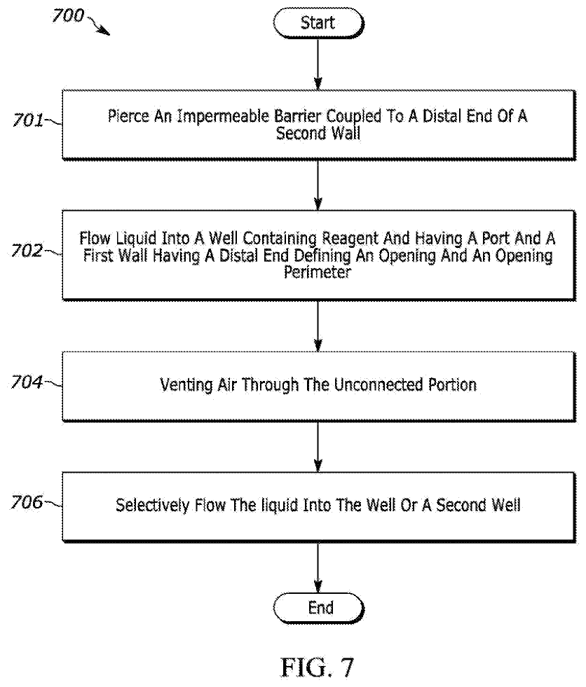

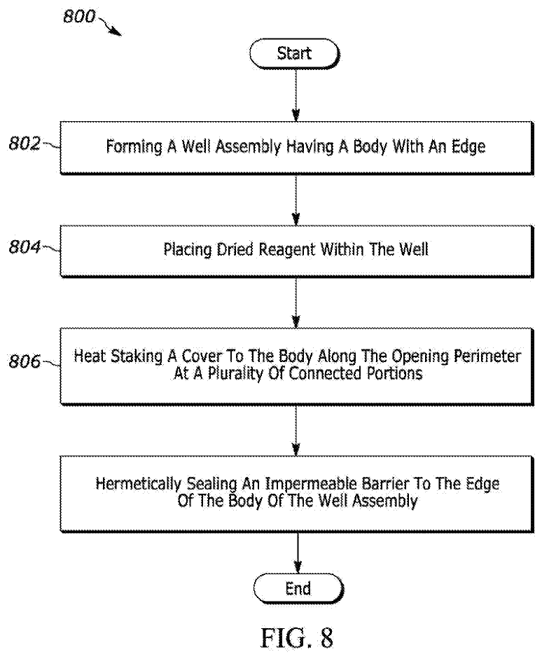

FIG. 7 illustrates a flowchart for a method of rehydrating the reagent 130 of the reagent cartridges 82, 200. FIG. 8 illustrates a flowchart for a method of manufacturing the well assemblies 102 of the reagent cartridges 82, 200 The order of execution of the blocks may be changed, and/or some of the blocks described may be changed, eliminated, combined and/or subdivided into multiple blocks.

The process 700 of FIG. 7 begins with piercing the impermeable barrier 126 that is coupled to the distal end 118 of the second wall 116 (Block 701). The second wall 116 surrounds the first wall 106. The liquid 129 is flowed into the well 107 containing reagent 130 and having the port 108 and the first wall 106 having the distal end 110 defining the opening 112 and an opening perimeter 114 (Block 702). The cover 120 is coupled to the distal end 110 of the first wall 106 and covers the opening 112 along the opening perimeter 114 at the connected portion 122 and uncoupled from the distal end 110 of the first wall 106 along the opening perimeter 114 at the unconnected portion 124. The distal end 110 of the first wall 106 has the annular surface 212 and the unconnected portion 124 is positioned between the cover 120 and the annular surface 212 in some implementations. The distal end 110 of the first wall 106 may define the notch 214 and the unconnected portion 124 is positioned between the distal end 110 and the cover 120. Air vents through the unconnected portion 124 (Block 704). The air may vent through the unconnected portion 124 as the liquid 129 rehydrates the reagent 130. The liquid 129 is selectively flowed into the well 107 or a second well 107, 211, 213 (Block 706). The liquid 129 may be selectively flowed into the well 107 or the second well 107, 211, 213 by rotating the valve rotor within the valve stator 204 between a first position that fluidically couples the liquid reservoir 144, the first stator port 206 of the valve stator 204, and the port 108 of the well 107, and a second position that fluidically couples the liquid reservoir 144, a second stator port 206 of the valve stator 204, and a port 108 of the second well 107, 211, 213.

The process 800 of FIG. 8 begins with forming a well assembly 102 having a body 104 with an edge 118, 146 (Block 802). The body 104 defines the well 107 having an opening 112 and a port 108. The opening 112 has an opening perimeter 1014. The dried reagent 130 is placed within the well 107 (Block 804). The well assembly 102 may be injection molded. Alternative processes for forming the well assembly are also possible, including for example 3D printing.

The cover 120 is heat staked to the body 104 along the opening perimeter 114 at a plurality of connected portions 122 (Block 806). Each connected portion 122 is adjacent to an unconnected portion 124 and each unconnected portion 124 forms a vent 128 that allows air flow while deterring cross-contamination. Heat staking the cover 120 to the body 104 may include applying the heat stake 400 to the cover 120 at a temperature of between about 200 degrees Celsius and about 220 degrees Celsius. The temperature may be above the melting point of the lacquer of the impermeable barrier 126. The cover 120 may be heat staked to the body 104 by applying the heat stake 400 to the cover 120 for a time period between about 1 second and about 3 seconds. The impermeable barrier 126 is hermetically sealed to the edge 118, 146 of the body 104 of the well assembly 102 (Bock 808). The cover 120 may be heat staked to the body 104 along the opening perimeter 114 at a plurality of connected portions 122 before the cover 120 is hermetically sealed to the edge 118, 146 of the body 104 of the well assembly 102.

At least one aspect of this disclosure is directed toward well assemblies that can be sealed using only foil while still retaining lyophilized reagents and allowing venting. The foil is heat staked to individual wells of a well assembly in an intermittently connected pattern including connected portions and unconnected portions. The connected portions prevent or inhibit the lyophilized reagent, such as microspheres, from escaping from an individual well. The unconnected portions allow air to vent from the individual well. Each well includes a port through which a liquid can be flowed to rehydrate the lyophilized reagent.

At least another aspect of this disclosure is directed to the manufacture of such well assemblies. The body of a well assembly is injection molded or otherwise formed, and then a cover for each well is heat staked to the body at connected portions along an opening perimeter of each well with unconnected portions of the cover allowing venting. Advantageously, the cover may be made out of foil. An impermeable barrier is hermetically sealed to an outer edge of the well assembly to provide a moisture barrier between the lyophilized reagent and the external environment. This process reduces manufacturing complexity and costs.

Yet another aspect of this disclosure is directed to the heat stake used in manufacture of such well assemblies. The heat stake includes a body that can be coupled to an actuator and a head connected to the body. The head includes a face with a staking surface that includes a plurality of recessed areas. The staking surface connects the cover to a well while leaving unconnected portions by virtue of the recessed areas in the staking surface. As described above, this allows a well assembly to both retain lyophilized reagent and to vent properly while simultaneously simplifying the materials and methods needed to manufacture such a well assembly.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

As used herein, an element or step recited in the singular and proceeded with the word “a” or “an” should be understood as not excluding plural of said elements or steps, unless such exclusion is explicitly stated. Furthermore, references to “one implementation” are not intended to be interpreted as excluding the existence of additional implementations that also incorporate the recited features. Moreover, unless explicitly stated to the contrary, implementations “comprising.” “including,” or “having” an element or a plurality of elements having a particular property may include additional elements whether or not they have that property. Moreover, the terms “comprising.” including,” having.” or the like are interchangeably used herein.

The terms “substantially.” “approximately,” and “about” used throughout this Specification are used to describe and account for small fluctuations, such as due to variations in processing. For example, they can refer to less than or equal to +5%, such as less than or equal to +2%, such as less than or equal to +1%, such as less than or equal to +0.5%, such as less than or equal to 10.2%, such as less than or equal to $0.1%, such as less than or equal to +0.05%.

The terms “connect.” “connected,” “contact,” “coupled” and/or the like are broadly defined herein to encompass a variety of divergent arrangements and assembly techniques. These arrangements and techniques include, but are not limited to (1) the direct joining of one component and another component with no intervening components therebetween (i.e., the components are in direct physical contact); and (2) the joining of one component and another component with one or more components therebetween, provided that the one component being “connected to” or “contacting” or “coupled to” the other component is somehow in operative communication (e.g., electrically, fluidly, physically, optically, etc.) with the other component (notwithstanding the presence of one or more additional components therebetween). It is to be understood that some components that are in direct physical contact with one another may or may not be in electrical contact and/or fluid contact with one another. Moreover, two components that are electrically connected, electrically coupled, optically connected, optically coupled, fluidly connected or fluidly coupled may or may not be in direct physical contact, and one or more other components may be positioned therebetween.

There may be many other ways to implement the subject technology. Various functions and elements described herein may be partitioned differently from those shown without departing from the scope of the subject technology. Various modifications to these implementations may be readily apparent to those skilled in the art, and generic principles defined herein may be applied to other implementations. Thus, many changes and modifications may be made to the subject technology, by one having ordinary skill in the art, without departing from the scope of the subject technology. For instance, different numbers of a given module or unit may be employed, a different type or types of a given module or unit may be employed, a given module or unit may be added, or a given module or unit may be omitted.

Underlined and/or italicized headings and subheadings are used for convenience only, do not limit the subject technology, and are not referred to in connection with the interpretation of the description of the subject technology. All structural and functional equivalents to the elements of the various implementations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

1. An apparatus comprising:
a body having:
a first wall defining a well having a port and a distal end defining an opening having an opening perimeter, and
a second wall surrounding the first wall and having a distal end;
a cover coupled to the distal end of the first wall and covering the opening along the opening perimeter at a connected portion and uncoupled from the distal end of the first wall along the opening perimeter at an unconnected portion; and
an impermeable barrier coupled to the distal end of the second wall and covering the well,
wherein the unconnected portion forms a vent that allows air flow out of the well.

2. The apparatus of claim 1, further comprising dried reagent contained within the well.

3. (canceled)

4. The apparatus of claim 2, wherein liquid is to flow into the well via the port and rehydrate the dried reagent.

5. (canceled)

6. The apparatus of claim 1, wherein the first wall has a height and the second wall has a height that is greater than the height of the first wall.

7. (canceled)

8. The apparatus of claim 1, wherein the body comprises a thermoplastic, and wherein the impermeable barrier includes a foil with a lacquer backing for bonding to the thermoplastic.

9. The apparatus of claim 1, wherein the body comprises a plurality of wells including the well, each of the plurality of wells having a corresponding opening and a port.

10. The apparatus of claim 9, wherein the body comprises a valve stator, a first stator port opening into the valve stator, a second stator port opening into the valve stator, a first fluidic line fluidically coupling the first stator port and the port of one of the plurality of wells, and a second fluidic line fluidically coupling the second stator port and the port of another one of the plurality of wells.

11. (canceled)

12. The apparatus of claim 1, wherein the distal end of the first wall defines a notch and the unconnected portion is positioned between the portion of the distal end and the cover.

13. The apparatus of claim 1, wherein the unconnected portion comprises a first unconnected portion and a second unconnected portion, and wherein a first portion of the distal end of the first wall defines a first notch and the first unconnected portion is positioned between the first notch and the cover and wherein a second portion of the distal end of the first wall defines a second notch and the second unconnected portion is positioned between the second notch and the cover.

14. (canceled)

15. The apparatus of claim 1, wherein portions of the distal end of the first wall define a plurality of notches, each notch having a notch length, the plurality of unconnected portions aligned with the plurality of notches, an unconnected length of each unconnected portion commensurate with the notch length of a corresponding notch.

16. The apparatus of claim 1, wherein the connected portion comprises a plurality of connected portions between which the cover and the distal end of the first wall are coupled and the unconnected portion comprises a plurality of unconnected portions between which the cover and the distal end of the first wall are uncoupled.

17. The apparatus of claim 16, wherein at least one of the unconnected portions of the plurality of unconnected portions is positioned between two of the connected portions of the plurality of connected portions and wherein the plurality of connected portions comprise radial connected portions and the plurality of unconnected portions comprise radial unconnected portions.

18. (canceled)

19. The apparatus of claim 1, further comprising a third wall defining a second well having a port and a distal end defining an opening having an opening perimeter, and a second cover coupled to the distal end of the third wall and covering the opening of the second well along the opening perimeter of the second well at a connected portion and uncoupled from the distal end of the third wall along the opening perimeter of the second well at an unconnected portion and wherein a fourth wall surrounds the third wall.

20-24. (canceled)

25. A method comprising:
flowing liquid into a well containing reagent and having a port and a first wall having a distal end defining an opening and an opening perimeter, a cover is coupled to the distal end of the first wall and covers the opening along the opening perimeter at a connected portion and uncoupled from the distal end of the first wall along the opening perimeter at an unconnected portion; and
venting air through the unconnected portion.

26. The method of claim 25, wherein the vent is sized to substantially retain the dried reagent within the well.

27. The method of claim 25, wherein the distal end of the first wall has an annular surface and the unconnected portion is positioned between the cover and the annular surface.

28. The method of claim 25, wherein the distal end of the first wall defines a notch and the unconnected portion is positioned between the distal end and the cover.

29. The method of claim 25, further comprising piercing an impermeable barrier coupled to a distal end of a second wall, the second wall surrounding the first wall.

30. The method of claim 25, further comprising selectively flowing the liquid into the well or a second well.

31. The method of claim 30, wherein selectively flowing the liquid into the well or the second well comprises rotating a valve rotor within a valve stator between a first position that fluidically couples a liquid reservoir, a first stator port of the valve stator, and the port of the well, and a second position that fluidically couples the liquid reservoir, a second stator port of the valve stator, and a port of the second well.

32-44. (canceled)
